(19) United States
(12) Patent Application Publication
(10) Pub. No.: US 2016/0181757 A1
(43) Pub. Date: Jun. 23, 2016

(54) MOPA WITH SELECTIVELY VARIABLE PULSE-DURATION

(71) Applicant: Coherent Kaiserslautern GmbH, Kaiserslautern (DE)

(72) Inventors: Markus LÜHRMANN, Kaiserslautern (DE); Christoph Oskar SCHÄFER, Dellfeld (DE); Sergey NAUMOV, Kaiserslautern (DE)

(21) Appl. No.: 14/938,608

(22) Filed: Nov. 11, 2015

Related U.S. Application Data
(60) Provisional application No. 62/094,906, filed on Dec. 19, 2014.

(51) Int. Cl. H01S 3/067; H01S 3/107; H01S 3/11

(52) U.S. Cl. CPC H01S 3/06754; H01S 3/1106; H01S 3/107

(57) ABSTRACT

MOPA apparatus includes a mode-locked fiber laser delivering seed-pulses to a regenerative amplifier. The seed-pulses are transported via one of two lengths of optical fiber. One of the lengths of fiber is significantly longer than the other, and significantly increases the duration of the seed-pulses. Amplified seed-pulses are compressed in a pulse-compressor. The pulse compressor delivers pulses having a pulse-duration of either a few picoseconds, or less than one picosecond, depending on whether the seed pulses are transported respectively by the longer or shorter of the lengths of optical fiber.

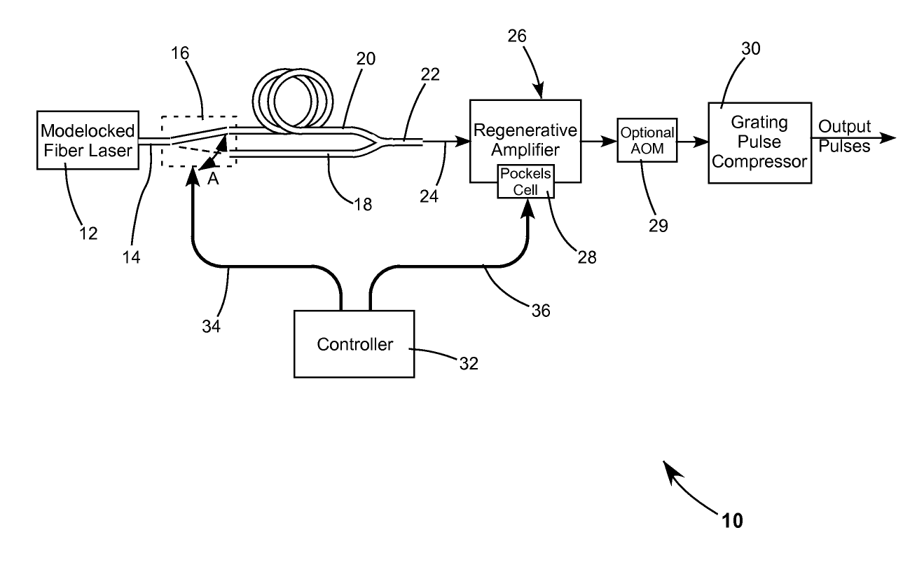

### PRIORITY

This application claims priority to U.S. Provisional Application, 62/094,906, filed Dec. 19, 2014, the disclosure of which is incorporated herein in its entirety.

### TECHNICAL FIELD OF THE INVENTION

The present invention relates in general to laser master-oscillator power-amplifier (MOPA) systems. The invention relates in particular to ultrafast MOPA systems delivering laser optical pulses having a duration of about 10 picoseconds (ps) or less at a predetermined pulse repetition frequency (PRF).

### DISCUSSION OF BACKGROUND ART

Pulsed, ultrafast MOPA systems are finding increasing use for a range of laser material modification and machining operations, including ophthalmic operations. A typical MOPA system includes a seed-pulse generator (master oscillator), a pulse stretcher (pulse-duration extender), one or more stages of optical amplification, and a pulse-compressor which compresses the amplified pulses to a desired pulse-duration with corresponding increase in peak intensity. A preferred pulse-compressor is a spaced-apart grating pair in which the degree of compression is determined, inter alia, by the spacing between the gratings.

Any particular operation may have a preferred pulse-duration for optimum effectiveness. By way of example, in ophthalmic operations, shaping a cornea for optical correction is typically carried out with pulses having a wavelength between about 1020 nanometers (nm) and 1070 nm a duration less than about 1 picosecond (ps). Cutting for lens replacement in cataract operations is carried out with 1064 nm pulses having a duration of about 10 ps or less.

Clearly, for a practitioner practicing such operations, having separate MOPAs for different operations would be expensive and inconvenient. Preferable would be a MOPA in which the pulse-duration could be selectively varied, cooperative with a common delivery apparatus.

One means of selectively varying pulse-duration is to utilize a pulse-compressor in which spacing between gratings can be varied. This requires expensive motorized precision stages and regulation circuitry for moving the gratings. The grating movement is relatively slow, and can also introduce changes in “pointing” of the laser-beam exiting the compressor, which may require a corresponding adjustment of the delivery apparatus.

Another means of selectively varying pulse-duration is to bypass the pulse-compressor for providing long-duration pulses, and utilize the compressor for providing short-duration pulses. This can be effected by switching the beam-path using a polarization rotator cooperative with a polarization-sensitive beam-splitter. The bypass beam-path and the beam path must be recombined to be compatible with the common delivery apparatus. Pointing variations can occur in the different beam paths.

There is a need for alternative means of selectively varying pulse-duration in ultrafast MOPA apparatus. This should be simple, fast, and provide constant beam-pointing, independent of selected pulse-duration.

### SUMMARY OF THE INVENTION

In one aspect optical apparatus in accordance with the present invention comprises a laser delivering a train of seed-pulses at a first pulse repetition frequency (PRF). An optical amplifier is provided for amplifying the seed pulses. An optical switch arranged to selectively couple the train of seed-pulses from the mode-locked laser into one of first and second path lengths of optical fiber for transporting the seed pulses to the optical amplifier for amplification therein, the second fiber path length being longer that the first fiber path length. The optical amplifier delivers amplified seed-pulses having one of a first pulse-duration and a second pulse-duration dependent on whether the seed pulses have been transported by respectively the first or second path lengths of optical fiber, the first duration being shorter than the second duration.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

THE DRAWING schematically illustrates a preferred embodiment of MOPA apparatus in accordance with the present invention, including a mode-locked laser delivering a train of seed-pulses, a fiber switch for selecting either one or the other of two different lengths of fiber through which the seed-pulses are transported, a regenerative amplifier including a Pockels cell switch for selecting pulses to be amplified from the transported train of seed-pulses and determining the number of round trips made by the selected pulses in the regenerative amplifier, according to which of the two different lengths of fiber is selected for transporting the seed-pulses to the regenerative amplifier.

### DETAILED DESCRIPTION OF THE INVENTION

THE DRAWING schematically illustrates a preferred embodiment 10 of MOPA apparatus in accordance with the present invention. MOPA 10 includes a mode-locked fiber laser 12 delivering a train of seed-pulses. The seed-pulses have a pulse-duration of about 10 picoseconds (ps) or less and are delivered at a pulse repetition frequency (PRF) in the tens of megahertz (MHz) with the specific PRF being determined, inter alia, by the length of optical fiber forming a resonator in the laser.

The train of pulses is transported by an optical fiber 14 to a fiber-switch 16, here shown very schematically. Switch 16 selects one of two optical fibers 18 and 20 through which the seed-pulses are transported as indicated by arrows A. Fiber 20 is many times longer than fiber 18. The duration of the transported pulses is increased by transport through either fiber 18 or fiber 20, with the increase being greater in the (longer) fiber 20. If fiber 18 is sufficiently short, for example, less than about 1 meter (m) the pulse-duration increase is negligible.

A detailed description of fiber switch 16 is not necessary for understanding principles of the present invention and accordingly is not presented herein. Fiber switches in various forms are well-known in the telecommunications art, and are commercially available. By way of example, such switches are available from Sercalo Microtechnology of Neuchatel, Switzerland.

In a practical example using the above referenced switch 16, fiber 18 does not actually exist as a separate element but is essentially within the switch 16, and so fibers 14 and 22 are essentially directly connected. Fiber 18 is included in the drawing for convenience of description and illustration. With such a direct connection, the total length of fiber between laser 12 and a regenerative amplifier 26 can be about 1 m. This can be considered for purposes of this description and the appended claims to be a first total path length of optical fiber transporting pulses from the laser to the amplifier. This length of fiber, as noted above, provides negligible increase in pulse duration. An exemplary length for fiber 20 is 50 m. This provides a second total path length of fiber of 51 mm.

Continuing with reference to THE DRAWING, the pulses either from the short fiber path length or the longer fiber path length exit fiber 22 and are propagated from fiber 22, in free-space (as depicted by arrow 24), to regenerative amplifier 26. Details of optics for such free-space propagation are well-known in the art and are omitted here for convenience of illustration. Further, as is known in the art, a solid-state regenerative amplifier includes an optical resonator (not shown) containing a solid-state gain-element (also not shown). The resonator also includes a Pockels cell (electro-optical) switch arrangement 28 including polarization-selective optical components (not shown) cooperative with a voltage-controlled birefringent crystal polarization-rotator (also not shown). The Pockels cell switch, here, admits selected pulses from the seed-pulse train into the amplifier resonator and ejects the admitted pulses after the pulses have made a predetermined number of round trips in the resonator. The number of round trips, together with other factors, determines the degree of amplification of the pulses and other parameters of the amplified pulses. The Pockels cell switch, in this arrangement, determines the PRF of amplified pulses.

Amplified pulses from regenerative amplifier 26 are delivered to a pulse-compressor 30, here, a grating pulse-compressor. The pulses can be delivered directly to the pulse-compressor or, optionally, via a pulse-picker 29, typically an acousto-optic modulator (AOM). The AOM can reduce the PRF of the pulses from that value convenient for the regenerative amplifier to a value convenient for a particular application. The AOM can also select pulses in an irregular sequence, or in bursts of pulses.

Pulse-compressor 30 reduces the duration and increases the peak-intensity of the amplified pulses received either directly or via AOM 29. Optical pulse-compressors are well known in the art to which the present invention pertains and can include gratings or prisms without departing from the spirit and scope of the present invention.

In this embodiment of the present invention, pulse-compressor 30 is a fixed compressor, and the duration of pulses output from the pulse-compressor is determined by the optical spectrum and duration of pulses input to the pulse-compressor. The input optical spectrum and pulse-duration are determined primarily by the seed-pulse-duration, the fiber path length through which seed-pulses are transported to regenerative amplifier 28, and any extension of the optical spectrum or pulse-duration occurring on amplification.

Dependent on which of fibers 18 and 20 is selected for seed-pulse transportation, certain adjustments of the operation of regenerative amplifier can be made. For example, the input (and correspondingly the output) PRF can be selected according to the path length of optical fiber through which the pulses are transported. The selected PRF can be the same or different. The selection of the PRF and number of round trips is controlled by a controller 32 which adjusts these parameters accordingly via a connection 36, when switch 16 is switched by the controller from one fiber to the other via a connection 34. Controller 32 may control other basic parameters of the MOPA apparatus, such as output power, as is known in the art. A detailed description of the above-discussed round-trip number and PRF adjustments is set forth below with reference to specific operating examples, in which the seed-pulses have a center wavelength of 1030 nm, a pulse-duration of about 1 ps, a PRF of about 40 MHz, an average output power of about 2 milliwatts (mW) and a spectral (optical) bandwidth of about 3.5 nm. The regenerative amplifier has a gain-element of ytterbium doped yttrium aluminum garnet (Yb:YAG)

In a first operating example, the seed-pulses are transported through the short path length of optical fiber (14+18+24 as depicted in THE DRAWING). This fiber path length is short enough, for example, about 25 centimeters (cm), that the duration of the seed-pulses is not significantly increased, and there is essentially zero optical dispersion. Some power loss occurs because of coupling losses in the fiber switch and connectors. Because of this, the average power of the seed-pulse train is reduced to about 1 mW.

The Pockels cell switch determines a PRF for input (and output) of the regenerative amplifier of about 400 kilohertz (kHz). When a pulse enters the regenerative amplifier, from round-trip to round-trip the energy of the amplified trip increases by an amplification factor. The amplification factor for the first round trip may be, for example, an order of magnitude, but decreases with each successive round trip until the amplification factor is only slightly higher than losses in the amplifier, at which point the amplified pulse is ejected by the amplifier. The number of round trips required for this can be determined readily by experiment and programmed into controller 32.

During most of the round trips, the spectral bandwidth of the pulse becomes smaller because of gain-narrowing and spectrally limited reflectivity of reflective optics of the amplifier. Assuming optical dispersion can be neglected, the pulse-duration increases as a result of the spectral-width narrowing. In the last round trips, the intensity of the pulse can be sufficiently high that self-phase modulation (SPM) occurs. This increases the spectral bandwidth of the pulses. Since the dispersion in the amplifier is not significant compared to this spectral bandwidth, the pulse-duration is not changed significantly. The number of round trips can be adjusted to “fine-tune” the SPM. Accordingly, it can be beneficial to adjust the number of round trips around that required to provide maximum output power to optimize the spectral bandwidth at the expense of abandoning some output power.

Considering the above, in the current example, at the amplified-pulse PRF of about 400 kHz, about 65 round trips in the regenerative amplifier creates amplified pulses having a pulse-duration of about 2 ps at an average power of about 9 Watts (W). The optical bandwidth prior to the onset of SPM can be reduced to about 1.0 nm, then increased by the SPM to about 5.0 nm.

If optional AOM 29 is included between the regenerative amplifier 28 and pulse-compressor 30, the average pulse power from the AOM will be reduced to about 7.5 W, even if all of the pulses from the regenerative amplifier are transmitted to the pulse-compressor. This is due to a limited transmitting efficiency (about 85% maximum) for an AOM. The average power will further decrease dependent on the number of pulses transmitted (picked) by AOM 29. The pulse-duration and spectral bandwidth remains the same, independent of how many pulses are transmitted by the AOM.

Group-delay dispersion (GDD) provided by the grating pulse-compressor is manually optimized so that output-pulses delivered from the pulse-compressor are as short as possible. After the optimization, the dispersion is fixed. The duration of pulses delivered from the pulse-compressor is about 400 femtoseconds (fs). The optical bandwidth of the pulses is about 5.0 nm.

In a second operating example, the seed-pulses are transported through the long fiber path (14+20+22 as depicted in the DRAWING). Fiber 20 is assumed to be a polarization-maintaining fiber having a length of about 50 m for a total path length of about 50.25 m. The pulse-duration of the seed-pulses is significantly increased by transmission through the long fiber, for example increased to about 10 ps, due to optical dispersion in the fiber. The optical bandwidth remains the same. As in the first example, some power loss occurs because of coupling losses in the fiber switch and connectors, and the average power of the seed-pulse train is reduced to about 1 mW as a result.

The regenerative amplifier is set to receive pulses for amplification at a PRF of about 160 kHz, i.e., less than half that for the shorter duration seed-pulses. The gain bandwidth of the amplifier is smaller than the optical bandwidth of the seed-pulses, which is also the case for the shorter-duration pulses. This results in only a fraction of a seed-pulse being amplified. In the above described example, for the shorter duration seed-pulses, this causes only a reduction in seed-pulse energy available to the amplifier, while the seed-pulse-duration stays about the same.

Because of GDD introduced by the 50 m-long fiber, the pulses are much more strongly “chirped” (frequency-modulated) than when transmitted through fiber 18. The dispersion is normal, and the chirp mostly linear. Longer wavelength (“red”) components of the pulses are at the front of the pulses, and shorter wavelength (“blue”) components are at the end of the pulses. The narrow gain-bandwidth of the amplifier results in red and blue components of the pulse not being amplified. This causes the effective pulse-duration of the pulses being amplified to be less than that of the input seed-pulses, for example, 4 ps in the cause of the 10 ps seed-pulses input to the regenerative amplifier.

During round trips of pulses being amplified in the regenerative amplifier the spectral bandwidth of the pulses again becomes smaller for reasons discussed above. The pulse-duration increases because of the narrower spectral width. In this longer-pulse example there, is no significant SPM as the pulses do not become intense enough to cause significant SPM. Because of this the spectral bandwidth of the pulses remains narrow.

In this second example, the output average power of the regenerative amplifier is about 9 W. The pulse-duration is about 4.5 ps and the pulse-bandwidth is about 1.0 nm.

Because the spectral bandwidth of the pulses is relatively narrow, relatively little compression of the pulses occurs in the pulse-compressor. In this example, a pulse having a duration of 4.5 ps input to the pulse-compressor is delivered from the pulse-compressor with a pulse-duration of about 3.5 ps, i.e., about an order of magnitude longer than in the first example. In this regard it should be noted that the length of fiber 20 is selected to be sufficiently long that pulse-intensities in the regenerative amplifier stay below the self-destruction limit of the amplifier at the lower PRF but at a level that would cause significant SPM. This avoids broadening the spectral bandwidth of the pulse significant pulse-compression in the pulse-compressor and consequently reduces pulse-compression below the level supported by the wider spectrum for the higher PRF.

Those skilled in the art will recognize from the detailed description of the present invention presented above that while the present invention is described above with reference to a MOPA having two selectable pulse-durations, such a MOPA could be configured to have more than two pulse-durations by providing more than two lengths of pulse-duration extension fiber, and appropriate fiber-switching arrangements. By way of example, such arrangements could include cascading two-way fiber switches to provide four-way fiber switching. Those skilled in the art may devise any such arrangement without departing from the spirit and scope of the present invention. Further, it should be noted that while PRF-selection in the above-described embodiment of the present invention is accomplished by the Pockels cell switch of the regenerative amplifier, PRF selection could be effected by a separate pulse-picker between the laser and the amplifier. This would be necessary in an embodiment wherein the regenerative amplifier were replaced by a linear amplifier or a fixed multi-pass amplifier.

In summary the present invention is described above with reference to a preferred embodiment with operating examples. The invention, however, is not limited to the embodiment and operating examples described herein. Rather, the invention is limited only to the claims appended hereto.

What is claimed is:

1. Optical apparatus, comprising:
a laser delivering a train of seed-pulses at a first pulse repetition frequency (PRF);
an optical amplifier;
an optical switch arranged to selectively couple the train of seed-pulses from the mode-locked laser into one of first and second path lengths of optical fiber for transporting the seed pulses to the optical amplifier for amplification therein, the second fiber path length being longer that the first fiber path length and;
wherein the optical amplifier delivers amplified seed-pulses having one of a first pulse-duration and a second pulse-duration dependent on whether the seed pulses have been transported by respectively the first or second path lengths of optical fiber, the first duration being shorter than the second duration.

2. The apparatus of claim 1 wherein the optical amplifier is a regenerative amplifier.

3. The apparatus of claim 2, further including a pulse compressor arranged to receive pulses from the optical amplifier and compress the pulses to one of a third duration and a fourth duration dependent on whether the pulses from the optical amplifier have respectively the first duration or the second duration, the third duration being shorter than the fourth duration.

4. The apparatus of claim 3, wherein the first second, third, and fourth durations are respectively about 2 picoseconds, about 10 picoseconds, about 400 femtoseconds, and about 3.5 picoseconds.

5. Optical apparatus, comprising:
a laser delivering a train of seed-pulses at a first pulse repetition frequency (PRF);
a regenerative optical amplifier;
an optical switch arranged to selectively couple the train of seed-pulses from the mode-locked laser into one of first and second path lengths of optical fiber for transporting the seed pulses to the regenerative optical amplifier for amplification therein, the second fiber path length being longer that the first fiber path length, with the optical amplifier delivering amplified seed-pulses having one of a first pulse-duration and a second pulse-duration dependent on whether the seed pulses have been transported by respectively the first or second path lengths of optical fiber, the first duration being shorter than the second duration; and
a pulse compressor arranged to receive pulses from the regenerative optical amplifier and compress the pulses to one of a third duration and a fourth duration dependent on whether the pulses from the regenerative optical amplifier have respectively the first duration or the second duration, the third duration being shorter than the fourth duration.

6. The apparatus of claim 5, wherein pulses being amplified by the regenerative optical amplifier make a predetermined number of round trips therein before being delivered from the regenerative optical amplifier, and wherein the predetermined number of round trips is predetermined dependent on whether the pulses have been transported to the regenerative amplifier by the first or second path length of optical fiber.

7. The apparatus of claim 6, further including an acousto-optic modulator between the regenerative optical amplifier and the pulse compressor for controlling a rate at which pulses from the regenerative optical amplifier are received by the pulse compressor.

8. An optical apparatus comprising:
a mode-locked fiber laser generating a series of output pulses;
an amplifier for amplifying the output pulses
a compressor for shortening the amplified pulses;
a first optical fiber between the fiber laser and the amplifier;
a second optical fiber between the fiber laser and the amplifier, with the second optical fiber being longer than the first optical fiber;
a switch for directing the output pulses into one of the first or second optical fibers, with the pulses exiting the selected fiber being delivered to the amplifier; and
a controller for controlling the switch to direct the output pulses into one of the first or second optical fibers to adjust the width of the pulses exiting the compressor.

9. An apparatus as recited in claim 8, wherein the amplifier is a regenerative amplifier that includes a Pockels cell for trapping pulses for multiple round trips within the regenerative amplifier.
